(19) United States
(12) Patent Application Publication
(10) Pub. No.: US 2025/0043157 A1
(43) Pub. Date: Feb. 6, 2025

(54) ADHESIVE TAPE FOR APPLYING TO AND REMOVING BY TWISTING OFF OR PRYING OFF OBJECTS FROM DELICATE SUBSTRATES

(71) Applicant: tesa SE, Norderstedt (DE)

(72) Inventors: Jan-Hendrik JENSEN, Hamburg (DE); Maren KAMPERS, Seevetal (DE); Andreas SCHROEDER, Hamburg (DE)

(73) Assignee: tesa SE, Norderstedt (DE)

(21) Appl. No.: 18/709,224

(22) PCT Filed: Nov. 9, 2022
(86) PCT No.: PCT/EP2022/081206

§ 371 Date: May 10, 2024

(30) Foreign Application Priority Data
Nov. 11, 2021 (DE) 10 2021 129 366.9

(51) Int. Cl. C09J 7/38; C09J 133/02; C09J 133/08

(52) U.S. Cl. CPC C09J 7/385; C09J 133/02; C09J 133/08; C09J 2203/366; C09J 2203/37; C09J 2301/1242; C09J 2301/16; C09J 2301/21; C09J 2301/302; C09J 2301/308; C09J 2301/412; C09J 2301/414; C09J 2301/502; C09J 2423/046; C09J 2433/00

(57) ABSTRACT

The present invention relates to a double-face adhesive tape that can be removed by twisting, prying or peeling off from, e.g., a wall without leaving residues. The present invention also relates to a method for the concealed mounting on and residue-free and non-destructive removal of objects from a sensitive substrate, wherein the object is affixed to the sensitive substrate by means of the double-face adhesive tape and, as and when necessary, is removed by twisting or prying or peeling.

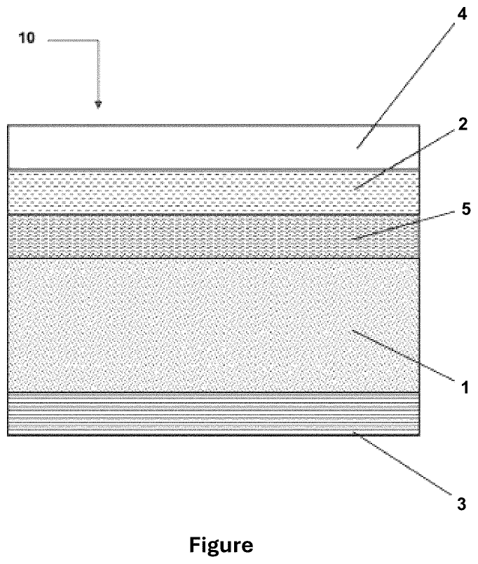

This application is a 371 of International Patent Application No. PCT/EP2022/081206, filed Nov. 9, 2022, which claims priority of German Patent Application No. 10 2021 129 366.9, filed Nov. 11, 2021, the entire contents of which patent applications are hereby incorporated herein by reference.

The present invention relates to a double-sided adhesive tape which can be removed from a wall for example by twisting or prying or peeling without any residue.

Photo tiles represent a recent concept in interior decoration. These photo tiles are mounted on the wall by the end user themselves. This should be possible easily and uncomplicatedly. At the same time, removal should be accomplished without damaging the wall. Mounting with an adhesive tape is desirable, as this can be done easily. However, removal may be accompanied by damage to the wall. Damage can occur especially with sensitive wall substrates. With painted plasterboard walls or painted plastered or wallpapered walls, paint may be detached because of the adhesive tape. Wallpapers, and in particular patterned wallpapers, both of paper and of nonwoven, can be split, causing parts of the decoration to be damaged.

Adhesive tapes are known on the market, e.g. tesa Power-Strips®, which can be removed from the wall without residue, damage or destruction by extensive stretching substantially parallel to the bonding plane, usually at an angle of no more than 35°. A disadvantage is that a certain protrusion of the adhesive tape over the edge of the object to be affixed is necessary in order to be able to apply the necessary pulling for removal. Such visibility of the adhesive tape beyond the edge of an object is often undesirable for visual reasons.

There is therefore a need for an adhesive tape which allows objects to be affixed directly to a wall and removed again without any residue. The adhesive tape should not be visible when the object is affixed to the wall. On removal of the object, even sensitive wall substrates should not be damaged. For example, no paint should be removed from painted walls or no wallpaper should be damaged (split). At the same time, there should as far as possible be no residues of the adhesive tape left on the wall.

Surprisingly, it has emerged that this is made possible by using a double-sided adhesive tape in which at least one adhesive comprises bead polymers. These allow for substantially residue-free and damage-free redetachability from different wall substrates.

### BRIEF DESCRIPTION OF THE FIGURE

The invention will now be described in greater detail with reference to the FIGURE, wherein the FIGURE is a schematic illustrating one embodiment of an adhesive tape according to the present invention.

In a first embodiment, the underlying object of the present invention is achieved by a double-sided adhesive tape which can be redetached without residue or destruction for the concealed bonding of objects to a wall, wherein the adhesive tape can be removed from the wall by twisting or prying or peeling, characterized in that that it comprises the following constituents:
a) a first adhesive,
b) a carrier comprising a carrier material, and
c) a second adhesive,
wherein the carrier material comprises a foam, and
the second adhesive comprises bead polymers.

Surprisingly, with an adhesive tape of the invention, objects can be securely affixed even to walls with sensitive surfaces, such as painted walls or wallpapers. In this case, in use, in accordance with the invention, the second adhesive faces the direction of the wall and the first adhesive faces the direction of the object or is affixed to the object. At the same time, by twisting off or prying, i.e. by applying torsion and/or lever and/or peeling forces, a residue-free removal in one step is made possible. In the application state, the adhesive tape is concealed behind the object to be affixed and thus allows the object to be bonded to the wall in a manner invisible to the user or observer of the object. No special device is required on the object. Nevertheless, the adhesive tapes have a simple structure.

When the object is removed from the wall, even sensitive wall surfaces are not destroyed. For instance, detachment from a wallpaper is possible without damaging a printed pattern, detaching paint from the wallpaper or splitting the wallpaper. At the same time, the adhesive tape itself is preserved, so that trouble-free repositioning of the objects is possible. In addition, the removal is easy to perform. Whereas with known adhesive tapes which can be removed by stretching, a pulling movement must take place as parallel as possible to the wall, i.e. parallel to the surface of the substrate, this restriction is specifically not necessary in the case of the adhesive tapes of the invention. These can be removed by applying torsion and/or lever and/or peeling forces, i.e. specifically not by pulling forces. This has the advantage that the adhesive tape can be completely concealed by the hanging object, since for removal it is specifically not necessary to be able to grip the adhesive tape on a sufficiently large area to exert a pulling movement.

Objects which can be affixed with the adhesive tape of the invention are, for example, pictures, posters, photo tiles, hooks, signs or other decorative objects. In particular, stiff objects, via which the torsion and/or lever and/or peeling forces can be applied directly, are preferred. The adhesive tape of the invention is particularly suitable for the mounting of photo tiles, signs, pictures or comparable decorative objects, which cause a certain load on the adhesive tape owing to their weight. Thus, with the adhesive tape of the invention, an object can preferably be affixed to a surface that exerts a shear load of 0.5 to 8 g per cm² of adhesive of the adhesive tape (g/cm²), preferably 1 to 6 g/cm², more preferably 1 to 4 g/cm².

Conventional adhesive tapes are capable of bearing shear loads of up to 17 g/cm². In contrast, the shear load which an adhesive tape of the invention can bear is low. Nevertheless, the peel adhesion of adhesives which comprise bead polymers is sufficient to affix objects to walls.

The adhesive tape of the invention is a double-sided adhesive tape. It comprises a carrier having an adhesive on both sides, wherein the first adhesive is located on a first surface of the carrier and the second adhesive on a second surface of the carrier, wherein the first surface and second surface of the carrier are opposite each other. The first and the second adhesive can be applied independently of each other over the full or a partial area on the corresponding side of the carrier material. Preferably, the first adhesive covers at least 50%, in particular at least 75%, preferably at least 80%, in particular preferably at least 85%, particularly preferably at least 90%, particularly at least 95% of the first surface of the carrier. Likewise preferably, the second adhesive covers at least 50%, in particular at least 75%, preferably at least 80%, in particular preferably at least 85%, particularly preferably at least 90%, particularly at least 95% of the second surface of the carrier. Preferably, the first and/or second adhesive, particularly preferably the first and the second adhesive, are applied over the full area of the carrier material.

In accordance with the invention, the carrier comprises a carrier material. Preferably, it consists of the carrier material. The carrier material comprises at least one foam, and preferably is a foam. This carrier material allows objects to be mounted to different types of surfaces, hence both uneven or even, and rough or smooth, surfaces. The surface, i.e. the wall surface, can thus be flat and even, such as a plastered, painted wall, or else textured, such as after application of a woodchip wallpaper or textured nonwoven or textile wallpapers. The carrier material of the invention thus adapts to both even and uneven, non-planar textured wall surfaces, such as, for example, woodchip wallpaper or textured nonwoven or textile wallpapers. The adhesive tape of the invention also allows objects to be mounted to non-planar surfaces, such as domed or curved surfaces—regardless of whether they are even or uneven.

In addition, the object is protected by the carrier material of the invention during mounting. On mounting, the object is pressed onto the wall. These forces pass into the adhesive tape, so that no pressure peaks occur locally on the object, but the force is distributed over the width of the adhesive tape.

Suitable foams are, for example, foamed polymers, such as a homo- or copolymeric olefin, in particular homo- and copolymers of ethylene, in particular polyethylenes (PE) of low and very low density (LDPE, LLDPE, VLDPE, ULLDPE), ethylene-vinyl acetate copolymers, and mixtures of aforesaid polymers. Other polymers may include: polyvinyl acetates, polypropylenes, polyurethanes based on aromatic and aliphatic diisocyanates, polystyrene, impact-modified polystyrenes, PVC, acrylate copolymers or rubbers. The foams can be used crosslinked or non-crosslinked. PE foams are preferred for use.

The thicknesses of the foam layers used to form the carrier, and thus of the carrier material, are in particular from 175 μm to 10 mm, preferably from 250 μm to 5 mm, particularly preferably from 300 μm to 2 mm, in particular preferably from 400 μm to 1 mm or from 500 μm to 750 μm. This enables the provision of a sufficiently thin adhesive tape, which allows the direct mounting of an object to walls without a large distance between the object and the wall. At the same time, unevennesses on the wall can be compensated well so as to allow good adhesion. Larger thicknesses would also increase the use of materials and can lead to process-related problems.

Accordingly, the total thickness of the carrier is also preferably 10 mm or less, in particular 6 mm or less, preferably 3 mm or less, in particular preferably 2 mm or less, particularly preferably 1.5 mm or less. This thickness can be achieved by one layer of foam or several layers of foam on top of each other.

The density of a foam material preferably used as a carrier material is in particular in the range from 20 to 200 kg/m³, preferably from 25 to 150 kg/m³, particularly preferably from 25 to 100 kg/m³, in particular preferably from 30 to 80 kg/m³. At lower densities, the carrier material can be split during the peeling process. This would leave residues of the adhesive tape on the wall.

The foam structure can be closed-cell, open-cell or mixed-cell. Skinned or unskinned foams of integral or non-integral structure can be utilized. According to the invention, laminates of several foams can also be used.

According to the invention, the second adhesive is located on a second side of the carrier. The second adhesive comprises bead polymers according to the invention.

Bead polymers are elastic spherical polymer particles. These inherently tacky pressure-sensitive adhesive microspheres are used, for example, for removable and reusable labelling materials, such as note paper, tape products and label products, for example. Based on this known use, it was not to be expected that adhesives comprising bead polymers, with sufficient anchoring on a suitable carrier material, are capable of accommodating loads of objects such as those which occur, for example, in the mounting of photo tiles or similar objects to walls.

Suitable bead polymers within the meaning of the present invention are thus inherently tacky elastic spherical polymer particles. Suitable polymers are, for example, acrylates, methacrylates, polyurethanes, vinyl acetate polymers, polyamides, polyvinyl chlorides, polystyrene, phenolic resins, epoxy resins, styrene-butadiene-styrene block copolymers, styrene-ethylene-butylene-styrene block copolymers, styrene-isoprene-styrene block copolymers, synthetic or natural rubber, such as nitrile rubber or chloroprene rubber, for example. These polymers can be used alone or in mixtures to form spherical polymers.

Preferably, the individual spheres of the bead polymer consist of a polymer or copolymer. However, it is also possible according to the invention for mixtures of different bead polymers to be used, thus for example mixtures of acrylate bead polymers with vinyl acetate polymers, to name only one example. Particularly preferred are acrylate polymers or vinyl acetate polymers each used alone as bead polymers. Particularly preferred are polymers or copolymers which have a glass transition temperature Tg of less than 0° C., in particular of −15° C. or less, preferably of −30° C. or less, particularly preferably of −50° C. or less.

As alkyl radicals which react together with acrylic acid or methacrylic acid to give esters, which then polymerize, in particular those with a C-chain length of 3 to 18, preferably from 4 to 15, in particular from 5 to 12, are selected. The alkyl radicals can be linear or branched.

Suitable monomers for the production of acrylate or methacrylate polymerizates of the invention are thus, for example, n-butyl acrylate, sec-butyl acrylate, 2-methylbutyl acrylate, 4-methyl-2-pentyl acrylate, 2-ethylhexyl acrylate, isooctyl acrylate, isodecyl methacrylate and the like, with n-butyl acrylate, sec-butyl acrylate, 2-methylbutyl acrylate, 4-methyl-2-pentyl acrylate, 2-ethylhexyl acrylate, isooctyl acrylate, isodecyl methacrylate being preferably used.

Processes for producing the bead polymers are sufficiently known to the skilled person and for example are described in U.S. Pat. No. 4,166,152 A, EP 0 710 678 A, U.S. Pat. No. 4,786,696 A, 3,691,140 A or EP 0 417 539 A2, the content of which is referred to in full in each case. Suitable processes for the production are thus various polymerization methods, such as suspension polymerization or emulsion polymerization or bulk polymerization or precipitation polymerization, for example.

Particularly preferably, the bead polymers, that is, the acrylate microspheres, have a particle diameter D50 in the range from 20 μm to 80 μm, in particular in the range from 25 μm to 70 μm, particularly preferably from 30 μm to 60 μm. Further preferably, the microspheres have a particle diameter D10 in the range from 10 μm to 40 μm, in particular from 15 μm to 25 μm. Furthermore, the microspheres preferably have a particle diameter D90 in the range from 50 μm to 100 μm, in particular from 60 μm to 90 μm, particularly preferably from 65 μm to 85 μm. In particular preferably, at least 93% of the particles, in particular at least 95% of the particles, have a diameter of less than 100 μm.

These particle diameters can be analysed by means of static laser light scattering. This can be done, for example, with a “Bettersizer S3 Plus” particle analyser from 3P Instruments. The microspheres are analysed by means of static light scattering and dynamic image analysis.

For the analysis, at room temperature, 10 drops of a water-based suspension (dispersing medium: DI water) of the microspheres were introduced by means of a pipette into the dispersion unit of the “Bettersizer S3 Plus”. The stirring speed was 1600 rpm. Before the measurement, dispersion was carried out over 60 s using the internal ultrasound (50 W). Averaging from 3 measurements was performed for the evaluation; the evaluation was carried out according to the Mie theory with a refractive index RI of 1.62-0.05i.

By default, the Bettersizer measurement is basically a measurement of the volume distribution—converting the result into a number distribution is a mathematical process. The measurement results were reported as D10, D50, and D90 values, which are standard percentiles. D50 is the size in micrometers (μm) for which 50% of the sample particles are smaller and 50% larger. This value is also known as the Mass Median Diameter (MMD) or the median of the volume distribution. D10 is the particle size below which 10% of the sample, and D90 the particle size below which 90% of the sample, is situated.

The second adhesive comprises bead polymers according to the invention. Preferably, it further comprises at least one binder, wherein the weight fraction of bead polymer in the second adhesive is 25% by weight, in particular 50% by weight or more. Preferably, the weight fraction of bead polymer in the second adhesive is up to 60% by weight or more, in particular at 70% by weight or more, preferably at 75% by weight or more, particularly preferably at 80% by weight or more, especially preferably at 90% by weight or more. In a particularly advantageous embodiment, the second adhesive comprises bead polymers in a fraction of 95% by weight or more or consists of bead polymers.

Suitable binders which are contained in the second adhesive are, for example, acrylate dispersions, polyurethanes, polyolefins, polyesters, rubber-based resins, resins based on silicone or vinyl acetate, preferably acrylate dispersions and vinyl acetate-based resins. Particularly preferred for use as binder are n-butyl acrylate, sec-butyl acrylate, 2-methylbutyl acrylate, 4-methyl-2-pentyl acrylate, 2-ethylhexyl acrylate, isooctyl acrylate, isodecyl methacrylate or mixtures of two, three or more of these. Binders that are chemically similar to the bead polymers are particularly preferred for use. Preferably, for example, acrylate-based bead polymers are therefore used, in combination with acrylate dispersions. As a result, the binder adheres well to the bead polymers and there are no unwanted reactions between the individual constituents of the adhesive.

According to the invention, the second adhesive may contain further additives—for example, crosslinking assistants. Preferably, the second adhesive consists of the bead polymer and the binder.

It has been shown that by appropriately adjusting the weight ratio of bead polymers to binder, the occurrence of adhesive residues on sensitive objects, such as painted or wallpapered walls, for example, can be minimized or even completely avoided.

In addition to the bead polymers and the binder, the second adhesive according to the invention may further comprise hollow spheres. These hollow spheres may be coated with an adhesive, in particular an acrylate adhesive. The hollow spheres are selected such that they have a diameter so that they protrude in parts from the layer of the adhesive; however, they are still covered with adhesive and thus imitate the bead polymers. There is also no complete contact with the wall substrate, i.e. there is only partial wetting of the wall surface with adhesive, limited to microscopically small areas.

Suitable hollow spheres can be made of glass or a plastic, for example. In particular, hollow glass spheres are used. These hollow spheres have a comparable size to the bead polymers. Accordingly, the hollow spheres, in particular hollow glass spheres, also have a particle diameter D50 in the range from 20 μm to 80 μm, in particular in the range from 25 μm to 70 μm, particularly preferably from 30 μm to 60 μm. Further preferably, the hollow spheres, in particular hollow glass spheres, have a particle diameter D10 in the range from 10 μm to 40 μm, in particular from 15 μm to 25 μm. Furthermore, the hollow spheres, in particular hollow glass spheres, preferably have a particle diameter D90 in the range from 50 μm to 100 μm, in particular from 60 μm to 90 μm, particularly preferably from 65 μm to 85 μm. The hollow glass spheres can be used as a partial replacement for the bead polymer microspheres. They result in a similar effect, namely improved adhesion to uneven surfaces.

The second adhesive preferably has an average layer thickness which essentially corresponds to the particle diameter of the bead polymers. The layer thickness of the adhesive layer which is formed by the second adhesive is thus in particular in the range from 1 μm to 1000 μm, in particular preferably from 5 μm to 750 μm, preferably from 10 μm to 500 μm, particularly preferably from 15 μm to 300 μm.

The adhesive tape according to the invention in a preferred embodiment has a covering layer (also called “release liner”) on the second adhesive. This covering layer is applied to the free side of the adhesive, i.e. to the side opposite the carrier. It protects the adhesive so that no dirt etc. adheres to it. In addition, the covering layer enables easier and improved handling. The covering layer is preferably a film, for example a plastic film, for example made of PET. A paper can also be used as a covering layer. The thickness of the covering layer is preferably 1 mm or less; more preferably, the thickness is in the range from 25 μm to 500 μm, particularly preferably from 30 μm to 300 μm, especially preferably from 35 μm to 100 μm. These thicknesses allow good protection of the adhesive, good removability and handling, with little material required at the same time.

Usually, such covering layers are functionalized to ensure easy removability from the adhesive by the end user. Suitable functionalizations are, for example, coatings with a silicone formulation. The skilled person is sufficiently aware of this. In addition, when the product is administered on a roll, the administration, i.e. the unrollability, should be guaranteed. Even in the case of automatic application to an object, a suitable covering must be provided, which is on the one hand easy to remove but on the other hand also has sufficient adhesion. Surprisingly, it has been shown that conventional functionalized covering layers are not suitable to cover the second adhesive according to the invention. Functionalized covering layers can be removed by simple touch or a strong draught. So that a covering layer adheres to an adhesive of an adhesive tape during transport and storage, but at the same time can be easily removed before use, the removal forces required to remove the covering layer from the adhesive tape are preferably at least 5 cN/cm. If a functionalized release liner is used, i.e. a functionalized covering layer, on the second adhesive, the removal force is less than 5 cN/cm.

According to the invention, the removal force required to remove the release liner from the second adhesive is preferably 5 to 10 cN/cm, in particular 10 cN/cm or more, preferably 15 cN/cm or more, particularly 25 cN/cm or more. Particularly preferably, the removal force does not exceed 100 cN/cm, in particular 85 cN/cm.

To determine the removal force, the adhesive tape of the invention is adhered to a rigid substrate. The release liner is removed at a removal speed of 300 mm/min with a removal angle of 90°.

In order to allow sufficient adhesion of the covering layer to the second adhesive, this covering layer is preferably not functionalized. According to the invention, a product with good handling and processability can thus be provided in a preferred embodiment with the use of a non-functionalized covering layer. At the same time, costs and process steps are saved, as functionalization is not necessary.

The adhesive tape of the invention further comprises a first adhesive compound on a first surface of the carrier, wherein the first surface and second surface of the carrier are opposite each other. When the adhesive tape is used as intended, the first adhesive connects the adhesive tape to the object itself. A commercially available adhesive which enables good adhesion to the object can therefore be used as the first adhesive. Suitable adhesives are for example acrylate adhesives, rubber-based adhesives, adhesives based on polyurethanes or cellulose, to name just the most common.

The adhesion of the adhesive tape of the invention to the object should be stronger than the adhesion to the wall, so that when the object is removed from the wall, the adhesive tape remains on the object. This allows the object to be hung on the wall again at a different place after being removed from the wall, without the need to replace the adhesive tape.

It is also possible according to the invention that the first adhesive also comprises bead polymers, as described for the second adhesive. In this embodiment, it is possible to remove the adhesive tape from the object. In particular in this configuration, attention must be paid to the adhesive force of the individual adhesives, so that when the object is detached, the adhesive tape first detaches from the wall (the sensitive substrate) and then can be removed from the object. However, the peel adhesion of the two adhesives can also be adjusted so that the adhesive tape first detaches from the object and then can be removed from the wall (the sensitive substrate) when twisted or pried or peeled off.

According to the invention, it is also possible that the first adhesive is one that allows the inventive adhesive tape to be removed from the object without residue or destruction by stretching substantially parallel to the bonding plane. Corresponding adhesives are often formed from block copolymers. They are adequately described in the prior art.

Particularly preferred presently as the first adhesive is an adhesive based on block copolymers containing polymer blocks formed by vinyl aromatics (A blocks), preferably styrene, and blocks formed by polymerization of 1,3-dienes (D blocks), preferably butadiene and isoprene. Both homo- and copolymer blocks can be used according to the invention. Resulting block copolymers may contain identical or different D blocks, which may be partially, selectively or fully hydrogenated.

Block copolymers may have linear A-D-A structure according to the invention. It is likewise possible to use block copolymers in radial form and star-shaped and linear multiblock copolymers. A-D two-block copolymers may be present as further components. Block copolymers may be modified, e.g. functionalized by reaction with maleic anhydride. Block copolymers of vinyl aromatics and isobutylene can also be used according to the invention. All of the aforementioned polymers can be used alone or in a mixture with each other.

Typical concentrations in which the styrene block copolymers are used are located in the range between 15% by weight and 75% by weight, preferably in the range between 30% by weight and 60% by weight, particularly preferably in the range between 35% by weight and 55% by weight.

The first and or the second adhesive may each independently of each other according to the invention comprise no, one or two or more further additives. Preferred additives are further explained below.

The following are particularly suitable as tackifiers: rosin and its derivatives, aliphatic, aromatically modified aliphatic, aromatic and phenol-modified tackifying resins. Use concentrations of the resins are typically in the range of 15% by weight and 75% by weight, preferably in the range of 30% by weight and 65% by weight, particularly preferably in the range of 35% by weight and 60% by weight.

As endblock-compatible resins (mainly resins compatible with the vinyl aromatic blocks), homolymers and copolymers of vinyl aromatics, such as styrene or α-methylstyrene, polyphenylene oxides, but also phenylene oxide-modified resins can be used.

Further optimal blend components which according to the invention can be contained in the first adhesive include plasticizer oils and liquid resins (use concentrations of 0 to max. around 35% by weight), fillers (reinforcing and non-reinforcing), e.g. silicon dioxide, in particular synthetic silica, glass (ground or in the form of spheres), aluminum oxides, zinc oxides, calcium carbonates, titanium dioxides, carbon blacks, aging inhibitors (primary and secondary antioxidants, light stabilizers, antiozonants, metal deactivators, etc.). Blend components also include polymers which have a particular effect on the ozone resistance of the block copolymers, such as polyvinyl acetates and ethylene-vinyl acetate copolymers.

Further polymers present may be natural and synthetic polymers, such as natural rubber, synthetic polyisoprenes, polybutadienes, polychloroprenes, SBR, Kraton Liquid (Shell Chemicals), polyisobutylenes, etc., which can replace the vinyl-aromatic-containing block copolymers at up to around 50% by weight.

The self-adhesive compounds used according to the invention for the first adhesive can be crosslinked chemically, in particular radiologically (e.g. by UV irradiation, 7-irradiation or by irradiation by means of fast electrons). First adhesives according to the invention are optionally those whose pressure-sensitive adhesiveness is generated only by thermal activation.

Suitable self-adhesive compounds for the first adhesive compound are, in addition to those previously described and based on vinyl-aromatic-containing block copolymers, also those which have sufficient tear resistance and cohesion for the detachment process. Appropriate pressure-sensitive adhesives can be used alone or in combination with those based on vinyl-aromatic-containing block copolymers. According to the invention, suitability is possessed for example by pressure-sensitive adhesive acrylate copolymers copolymerized with macromonomers, wherein the macromonomers have a glass temperature of >+40° C. The high tear resistance of corresponding copolymers is probably achieved by the association of the macromonomers. Suitable macromonomers are, for example, methacryloyl-terminated polymethyl methacrylates.

The layer thickness of the first adhesive is preferably from 5 μm to 1000 μm, in particular preferably from 15 μm to 750 μm, preferably from 30 μm to 500 μm, particularly preferably from 50 μm to 300 μm. This allows good adhesion.

In order to improve the adhesion of the second adhesive to the second surface of the carrier, the second surface of the carrier is functionalized or has a primer in a preferred embodiment.

For example, primers may be selected from the group of polyacrylates or polyurethanes. A physico-chemical pretreatment by deposition of fluorine into the surface of the carrier material, for example, leads to an improvement in the adhesion of the bead polymers, so that the bead polymers adhere to the carrier material and not to the wall on detachment.

Treatment of the carrier surface by means of plasma or corona also enables improved adhesion of the adhesive to the carrier material.

In a further-preferred embodiment, the adhesive tape of the invention further comprises at least one reinforcing layer, in particular one or two, preferably one reinforcing layer, which is applied to the second surface of the carrier. According to the invention, it is thus possible that the adhesive tape has one, two, three or more reinforcing layers. In particular, it has one, two or three reinforcement layers, preferably one or two. More than one reinforcing layer is particularly preferred when both the object and the wall surface are very sensitive, especially with regard to the mounting and removal of an adhesive tape.

Preferably, the surface tension of the surface of the reinforcing layer which is oriented toward the second adhesive is 40 mN or more, in particular 45 mN or more, particularly preferably 50 mN or more, in particular preferably 60 mN or more.

The determination of the surface tension is sufficiently known to the skilled person. It can be carried out, for example, with a dedicated test kit containing liquids with known surface tension in relation to surfaces. The surface tension can be determined in accordance with DIN ISO 8296:2008-03. The test kits are available, for example, from Ahlbrandt, Lauterbach, Germany (test ink case set for determining the surface tension according to DIN ISO 8296).

One such preferred embodiment is schematically illustrated in the FIGURE. The adhesive tape shown there has a carrier (1), the first surface of which is directly adjoined by a first adhesive (3). A reinforcing layer (5) is first mounted to the opposite second surface, and the second adhesive (2) is then located on said layer. The second adhesive (2) is protected on the free surface with a covering layer (4). The first adhesive (1) can be in direct contact with an object, that is, be mounted to it thereby. It is also possible that an additional covering is applied to the first adhesive (1), which is removed before use.

After the removal of the covering layer (4) from the second adhesive (2), the adhesive tape can be mounted with this adhesive (2) to a sensitive substrate, for example a wall which is painted and/or wallpapered and/or plastered.

Thus, a reinforcing layer (5) is preferably applied on the carrier (1), and is fixed, for example by means of a further adhesive layer, by means of heat sealing or ultrasound on the carrier (1) and thus this construct of carrier (1) and reinforcing layer (5) can be regarded as a carrier material composite. This carrier material composite can then be coated with adhesive on the respective sides; the second adhesive (2) is then applied to the reinforcing layer (5) and the first adhesive (3) is applied to the carrier (1).

The at least one reinforcing layer (5) also enables improved adhesion of the second adhesive (2) on the carrier (1) or in this embodiment of the carrier material composite, and thus allows the absorption of shear loads, even if these are low, and ensures a residue-free detachment of sensitive objects.

The at least one reinforcing layer (5) is preferably selected from nonwovens or films. The films can be made of plastic fibers, such as fibers made of PP (polypropylene), PA (polyamides), PE (polyester) or PET (polyethylene terephthalates). Films made of natural fibers are also suitable. Suitable natural fibers include for example hemp fibers or cellulose fibers. Stiffness and thickness can be selected according to the desired application.

Preferably, the reinforcing layer (5) on the second surface of the carrier (1), on which the second adhesive (2) is applied, is functionalized or modified. This allows the surface tension of the reinforcing layer surface to be adapted. The functionalization/modification of the reinforcing layer (5) can be performed in the same way as the functionalization of the carrier (1). Preferred reinforcing layers (5) are, for example, PET films, in particular PET films in which one or both surfaces, in particular one surface, is functionalized or modified. Functionalization or modification can be done, for example, by etching. Modification with suitable primers is also possible. Furthermore, physical treatment methods are possible, such as treatment with radiation (e.g. UV radiation), by means of corona or plasma, or a flame pretreatment procedure.

The adhesive tape of the invention may also have a covering layer on the first adhesive (3). This is then applied to the surface of the first adhesive (3) which is opposite the carrier (1). Preferably, this covering layer is functionalized on the side facing the first adhesive (3), in order to allow simple detachment from the first adhesive (3). The functionalization is of particular interest when the first adhesive (3) contains no bead polymers.

The skilled person is sufficiently aware of corresponding covering layers, also with a functionalized surface on the side which faces the adhesive.

The total thickness of the adhesive tape of the invention is in particular from 250 μm to 10 mm, preferably from 350 μm to 5 mm, particularly preferably from 450 μm to 3 mm, especially preferably from 550 μm to 2.

In a further embodiment, the underlying object of the present invention is achieved by the use of adhesives which comprise bead polymers for producing a double-sided adhesive tape for the concealed affixing of objects to sensitive substrates, where the adhesive tape can be removed from the sensitive substrate by twisting or prying or peeling. A sensitive substrate is, for example, a wall that is damaged when conventional adhesive tapes are detached, such as a painted or wallpapered wall.

In yet another embodiment, the underlying object of the present invention is achieved by a method for the concealed mounting and residue-free and non-destructive removal of objects on sensitive substrates, which is characterized in that the object is affixed to a sensitive substrate by means of an adhesive tape as described above and, as and when necessary, is removed by twisting or prying or peeling.

The method according to the invention therefore comprises the embodiment wherein a double-sided adhesive tape of the invention is already affixed to an object and a covering layer is to be removed in order to affix the object to a sensitive substrate (wall) by means of the adhesive tape in such a way that the adhesive tape is not visible. If the object is to be removed, this is possible at any time by twisting or prying or peeling.

In the case of removal of the object from the wall, therefore, torsion and/or lever and/or peeling forces are applied in particular, in other words specifically no tensile forces in the extension direction of the bond, as are necessary with known adhesive tapes which lose their stickiness when stretched extensively, such as the tesa Powerstrips, for example. This method of removal also allows the force not to be applied substantially parallel to the wall, i.e. in the direction of extension. Rather, the object can be removed in an ordinary hand movement, where the peeling angle can be 30° or more, in particular 35° or more, preferably 40° or more, particularly preferably 45° or more. The peeling angle corresponds to the force effect in relation to the plane of the sensitive substrate.

If the adhesive tape of the invention is removed from a wall, for example, the peeling or twisting or prying off can be carried out substantially perpendicularly to the wall. This allows for easier handling. A rigid substrate, such as a photo tile, for example, can be removed from the wall by a simple rotational motion for example.

All embodiments of the present application may be combined with one another without limitation in any manner. Where ranges of quantities are disclosed, all intermediate ranges shall also be deemed to be disclosed.

In the following working examples, the present invention is further explained in a non-limiting manner.

### WORKING EXAMPLES

Several specimens of single-sided adhesive tapes consisting of the carrier material coated with the second adhesive comprising bead polymers, as prototypes for the double-sided adhesive tapes of the invention, were produced and used to test the gap susceptibility and removability from wall surfaces of sensitive substrates.

### Production of the Adhesive Tapes

The double-sided adhesive tapes of the invention were produced as follows: For the production of the self-adhesive preliminary materials, a pretreated PET film with a thickness of 12 μm and an area of around 30 cm×35 cm was coated on a laboratory coating machine using a movable coating bar with the aqueous adhesives according to Table 1, which reports the fraction in % by weight of the adhesive.

TABLE 1

Adhesive (in % by weight)

| No. | Bead polymers | Binder |
|---|---|---|
| 1 | 100 | 0 |
| 2 | 90 | 10 |
| 3 | 75 | 25 |
| 4 | 50 | 50 |
| 5 | 25 | 75 |
| 6 | 0 | 100 |

For this purpose, the coating bar has a coating gap when the distance to the film surface is suitably implemented. For the coating process, the aqueous acrylate dispersion is evenly distributed over the film width in front of the coating bar and then distributed exactly homogeneously through the coating gap on the film in the required layer thickness (target surface weight of 12 g/m2) by means of machine movement of the coating bar. This preliminary material was then dried for 10 min at 100° C. in a commercially available drying oven so that the water was removed from the adhesive. To protect the adhesive, a release liner was then placed on manually and fixed without wrinkles using a hand roller.

For the production of the double-sided adhesive tapes according to the objective, a commercially available double-sided adhesive foam tape (e.g. Tesa® 64962, 1600 μm double-sided PE foam tape from tesa SE, Norderstedt, Germany) with a product thickness of about 1.6 mm (without release liner) was presented and merged with the non-adhesive side of the preliminary material and rolled up without wrinkles using a hand roller.

A polymer based on 2-ethylhexyl acrylate was used as the bead polymer, wherein the diameter D10 was 8 μm to 18 μm, the diameter D50 was 40 μm to 50 μm and the diameter D90 was 65 μm to 90 μm, with at least 97% of the polymers having a diameter of less than 100 μm.

An acrylate binder (aqueous acrylate dispersion based on 2-ethylhexyl acrylate and methacrylic acid) was used as the binder.

### Measurement Method—Removability

To determine the removability or the gap susceptibility, a test specimen was prepared from a strip-shaped specimen of the adhesive tape and a stiff rigid-foam board by bonding the adhesive tape by the permanently adhesive side onto the rigid-foam board. The rigid-foam board had a width of 5 cm and a length of 20 cm. The adhesive tape specimen was 5 cm long and 1.5 cm wide. It was adhered in the width direction of the rigid-foam board, so that it was flush with a length of 20 cm at both side edges of the rigid-foam board. The distance between the longitudinal edge of the adhesive tape with a length of 5 cm and the side edge of the rigid-foam board with a length of 5 cm was 1 cm.

After removal of the covering layer from the removably adhesive side, the test specimen was placed on a substrate and pressed for 5 s by means of a weight of 3.3 kg placed on it. Immediately after the pressing time had been completed, the test specimen was manually pried off within a time interval of 1 s by manually folding the end of the test specimen opposite the bonding in the direction of the bonding.

### Description of Sensitive Substrates:

As sensitive substrates with regard to the gap susceptibility of the wall surfaces, the two substrates used for the present invention were
(1) woodchip wallpaper of type “Classico” from Erfurt (Wuppertal, Germany) and painted with the wall paint “Alpinaweiß Das Original” from Alpina Farben GmbH (Ober-Ramstadt, Germany) and
(2) paper wallpaper with pattern no. DFU2297 “Cars” from Graham & Brown Ltd (Blackburn, United Kingdom)

For the production of the test specimens, the above-stated wallpapers were applied to rigid board material (wood chipboard or Eternit board) in the approx. 15 cm×15 cm format and, where appropriate, primed and, where appropriate, painted 2× with “Alpinaweiß Das Original”. In the case of the plasterboard (Eternit board), for reasons of rigidity, plasterboard panels with a thickness of 12 mm were used for the realistic reproduction of application to the wall, which also belong to the DIY standard, and were primed and 2× painted (see above). The coatings were dried for 3 days minimum under ambient conditions.

The results for removability or gap susceptibility are shown in the Table 2 below, with the result columns each indicating which area of the adhesive tape that was in contact with the wallpaper contained constituents of the wallpaper after removal. The proportions of bead polymer and binder are given in % by weight. The average value from 3 to 5 measurements is shown in each case.

TABLE 2

| | Adhesive | | Results - Removability | |
|---|---|---|---|---|
| No. | Bead polymers | Binder | Woodchip wallpaper | “Cars” wallpaper |
| 1 | 100 | 0 | 2 | 0 |
| 2 | 90 | 10 | 3 | 0 |
| 3 | 75 | 25 | 10 | 0 |
| 4 | 50 | 50 | 16 | 0 |
| 5 | 25 | 75 | 13 | 33 |
| 6 | 0 | 100 | 25 | 100 |

The binder itself was sticky. However, large areas of the wallpaper were also removed during removal. A fraction of just 25% by weight of bead polymers in the adhesive already led to a significant improvement. With a fraction of 50% by weight and in particular of 75% by weight of bead polymers, both wallpapers were virtually no longer damaged.

1. A double-sided adhesive tape (10) which can be redetached without residue or destruction by twisting or prying or peeling, for the concealed bonding of objects to sensitive substrates,
comprising the following constituents:
a) a first adhesive,
b) a carrier comprising a carrier material, and
c) a second adhesive,
wherein the carrier material comprises a foam, and
the second adhesive comprises bead polymers.

2. The double-sided adhesive tape as claimed in claim 1, wherein the thickness of the carrier material is 175 μm to 10 mm.

3. The double-sided adhesive tape as claimed in claim 1, wherein the thickness of the carrier is 10 mm or less.

4. The double-sided adhesive tape as claimed in claim 1, wherein the second adhesive compound comprises bead polymers and binders, wherein the weight fraction of bead polymers is 25% by weight or more.

5. The double-sided adhesive tape as claimed in claim 4, wherein the binder is selected from acrylate dispersions, polyurethanes, polyolefins, polyester, rubber-based resins, resins based on silicone or vinyl acetate.

6. The double-sided adhesive tape as claimed in claim 1, wherein the bead polymers are inherently tacky elastic spherical polymer particles, wherein the polymers are selected from acrylates, methacrylates, polyurethanes, vinyl acetate polymers, polyamides, polyvinyl chlorides, polystyrene, phenolic resins, epoxy resins, styrene-butadiene-styrene block copolymers, styrene-ethylene-butylene-styrene block copolymers, styrene-isoprene-styrene block copolymers, and synthetic or natural rubber.

7. The double-sided adhesive tape as claimed in claim 1, wherein the bead polymers have a particle diameter D50 in the range from 20 μm to 80 μm.

8. The double-sided adhesive tape as claimed in claim 1, wherein the bead polymers have a particle diameter D10 in the range from 10 μm to 40 μm.

9. The double-sided adhesive tape as claimed in claim 1, wherein the bead polymers have a particle diameter D90 in the range from 50 μm to 100 μm.

10. The double-sided adhesive tape as claimed in claim 1, wherein the carrier on a surface directed toward the second adhesive is functionalized or has a primer.

11. The double-sided adhesive tape as claimed in claim 1, which further comprises a reinforcing layer, which is applied to the carrier on a surface directed toward the second adhesive.

12. The double-sided adhesive tape as claimed in claim 11, wherein the reinforcing layer on the surface directed toward the second adhesive is functionalized.

13. The double-sided adhesive tape as claimed in claim 11, wherein the reinforcing layer is a nonwoven or a film.

14. The double-sided adhesive tape as claimed in claim 1, which further comprises a second covering layer on the second adhesive.

15. The double-sided adhesive tape as claimed in claim 14, wherein the second covering layer on the second adhesive has no functionalization.

16. The double-sided adhesive tape as claimed in claim 1, which further comprises a first covering layer on the first adhesive, wherein this first covering layer is optionally functionalized.

17. (canceled)

18. A method for the concealed mounting on and residue-free and non-destructive removal of objects from a sensitive substrate, comprising affixing the object to the sensitive substrate by means of an adhesive tape as claimed in claim 1 thereafter removing the adhesive tape by twisting or prying or peeling.

19. The method as claimed in claim 18, wherein torsion and/or lever and/or peeling forces are applied when twisting or prying or peeling the object from the substrate.
